(19) United States
(12) Patent Application Publication
(10) Pub. No.: US 2025/0125473 A1
(43) Pub. Date: Apr. 17, 2025

(54) OUTDOOR MOBILE POWER SUPPLY AND ELECTRONIC ASSEMBLY

(71) Applicant: GOPOD GROUP HOLDING LIMITED., Shenzhen (CN)

(72) Inventors: Zhuowen LIAO, Shenzhen (CN); Xingwang SONG, Shenzhen (CN); Long MIAO, Shenzhen (CN)

(21) Appl. No.: 18/646,705

(22) Filed: Apr. 25, 2024

Related U.S. Application Data
(63) Continuation of application No. PCT/CN2023/127984, filed on Oct. 30, 2023.

(30) Foreign Application Priority Data
Oct. 13, 2023 (CN) 202311326239.3

(51) Int. Cl. H01M 50/269; H01M 50/256; H01M 50/258; H01M 50/284; H01M 50/51; H02J 7/00

(52) U.S. Cl. CPC H01M 50/269; H01M 50/256; H01M 50/258; H01M 50/284; H01M 50/51; H02J 7/0063

(57) ABSTRACT

The disclosure discloses an outdoor mobile power supply and an electronic assembly, and belongs to the technical field of electronic assemblies. The outdoor mobile power supply comprises a base assembly, a guide rail member, a telescopic member and a first battery. The guide rail member is arranged on the base assembly; the telescopic member is arranged on the base assembly, and a part of the telescopic member is located in the guide rail member; and the first battery is arranged on the guide rail member and sleeved on the telescopic member, and one end of the first battery far away from the guide rail member is provided with a first electrical connection portion. According to the outdoor mobile power supply, a user can flexibly assemble and disassemble the battery according to the needs of use and mobile transportation, thus effectively improving the convenience of use, carrying and moving.

### CROSS-REFERENCE TO RELATED APPLICATION

The present disclosure claims the priority of the Chinese patent application filed on Oct. 13, 2023 to the China National Intellectual Property Administration with the application number of 202311326239.3, and the title of “OUTDOOR MOBILE POWER SUPPLY AND ELECTRONIC ASSEMBLY”, which is incorporated herein in its entirety by reference.

### TECHNICAL FIELD

The present disclosure relates to the technical field of electronic assemblies, and particularly to an outdoor mobile power supply and an electronic assembly.

### BACKGROUND OF THE PRESENT INVENTION

Outdoor mobile power supply is a special portable mobile power supply, which is mainly used for power supply in outdoor environment, wherein a large-capacity battery is usually used as an energy source, which may provide power for various outdoor devices, such as camping lamps, mobile phones, tablets, cameras, unmanned aerial vehicles, GPS and speakers.

The outdoor mobile power supply is mostly used in outdoor travel and various mobile devices, so that a large capacity is needed compared with a conventional mobile power supply. Therefore, there are more cells in a single battery, which means that a weight of the outdoor mobile power supply is heavier than that of the conventional mobile power supply.

However, multiple batteries may be mounted in most of existing outdoor mobile power supplies to expand capacities, and because a single battery itself is relatively heavy, the outdoor mobile power supply provided with the multiple batteries may be more bulky, and such bulky outdoor mobile power supply is inconvenient to carry and move.

### SUMMARY OF THE PRESENT INVENTION

In view of this, the present disclosure is intended to overcome the defects in the prior art and to provide an outdoor mobile power supply.

In order to solve the above technical problem, the present disclosure provides:
an outdoor mobile power supply, which comprises:
a base assembly;
a guide rail member, wherein the guide rail member is arranged on the base assembly;
a telescopic member, wherein the telescopic member is arranged on the base assembly, and a part of the telescopic member is located in the guide rail member; and
a first battery, wherein the first battery is arranged on the guide rail member and sleeved on the telescopic member, and one end of the first battery far away from the guide rail member is provided with a first electrical connection portion.

In addition, the outdoor mobile power supply according to the present disclosure may also have the following additional technical features.

In some embodiments of the present disclosure, the outdoor mobile power supply further comprises at least one second battery, one second battery is sleeved on the telescopic member and electrically connected with the first electrical connection portion, and the remaining second batteries are sleeved on the telescopic member in an axial direction of the telescopic member in sequence and electrically connected in sequence.

In some embodiments of the present disclosure, the second battery is provided with a second electrical connection portion and a third electrical connection portion, the second electrical connection portion and the third electrical connection portion are respectively located at two ends of the second battery, a second electrical connection portion of one second battery is electrically connected with the first electrical connection portion, and a third electrical connection portion of one second battery is electrically connected with a second electrical connection portion of an adjacent second battery.

In some embodiments of the present disclosure, the outdoor mobile power supply further comprises a circuit board, and the circuit board is arranged in a shell of the first battery and electrically connected with the first battery.

In some embodiments of the present disclosure, the circuit board is provided with a charging interface, and the shell of the first battery is provided with a first avoidance hole matched with the charging interface.

In some embodiments of the present disclosure, the circuit board is provided with a power button, and the shell of the first battery is provided with a second avoidance hole matched with the power button.

In some embodiments of the present disclosure, the base assembly comprises a base, a sliding member, a supporting stand and a supporting member, the guide rail member is arranged on the base, the sliding member is slidably sleeved on the guide rail member, one end of the supporting stand is hinged with the sliding member, and the supporting member is hinged with the supporting stand and the base respectively.

In some embodiments of the present disclosure, the base assembly further comprises a triggering apparatus, the triggering apparatus is arranged in the sliding member, the triggering apparatus comprises a hand-shifting member, a clamping member and an elastic member, the sliding member is provided with a first through hole and a second through hole, the hand-shifting member movably penetrates through the first through hole and is connected with the clamping member, one end of the clamping member movably penetrates through the second through hole and abuts against the guide rail member, and the elastic member abuts against one end of the clamping member far away from the second through hole and the sliding member respectively.

In addition, the present disclosure further provides an electronic assembly, which comprises an electronic device and the outdoor mobile power supply in any one of the above embodiments.

In some embodiments of the present disclosure, one end of the electronic device is provided with a fourth electrical connection portion electrically connected with the first electrical connection portion.

Compared with the prior art, the present disclosure has the beneficial effects as follows.

The present disclosure provides the outdoor mobile power supply, and the outdoor mobile power supply comprises the base assembly, the guide rail member, the telescopic member and the first battery. By arranging both the guide rail member and the telescopic member on the base assembly, and locating one part of the telescopic member in the guide rail member, a function of stably mounting the guide rail member and the telescopic member is realized, and the telescopic member can be extended or retracted relative to the guide rail member. By arranging the first battery on the guide rail member and sleeving the first battery on the telescopic member, a function of stably mounting the first battery is realized, and meanwhile, by arranging the first electrical connection portion at one end of the first battery far away from the guide rail member, when the outdoor mobile power supply is used, a user can extend the telescopic member and sleeve other batteries on the telescopic member in series in sequence, so as to expand a capacity of the outdoor mobile power supply, and when the outdoor mobile power supply is transported, the user can remove other batteries from the telescopic member in sequence and retract the telescopic member, so as to reduce a weight of the outdoor mobile power supply, thus being convenient to use, carry and move. According to the outdoor mobile power supply provided by the disclosure, a user can flexibly assemble and disassemble the battery according to the needs of use and mobile transportation, thus effectively improving the convenience of use, carrying and moving.

### DESCRIPTION OF THE DRAWINGS

In order to illustrate technical solutions in embodiments of the present disclosure more clearly, the drawings which need to be used in the embodiments will be briefly introduced hereinafter. It is to be understood that the following drawings only show some embodiments of the present disclosure, so that the drawings should not be regarded as limiting the scope. Those of ordinary skills in the art may further obtain other related drawings according to these drawings without going through any creative work.

FIG. 1 is a stereoscopic diagram of an outdoor mobile power supply in some embodiments of the present disclosure;

FIG. 2 is a stereoscopic diagram of the outdoor mobile power supply in FIG. 1 without a first battery;

FIG. 3 is a stereoscopic diagram of the first battery in some embodiments of the present disclosure;

FIG. 4 is a stereoscopic diagram of the first battery in FIG. 3 without a shell;

FIG. 5 is a stereoscopic diagram of a guide rail member and a base assembly in some embodiments of the present disclosure;

FIG. 6 is a stereoscopic diagram of FIG. 5 without a sliding member;

FIG. 7 is a stereoscopic diagram of FIG. 6 without the guide rail member;

FIG. 8 is a stereoscopic diagram of an electronic assembly in some embodiments of the present disclosure; and

FIG. 9 is a stereoscopic diagram of an electronic device in some embodiments of the present disclosure.

Reference numerals of major elements:
100 refers to outdoor mobile power supply; 110 refers to base assembly; 111 refers to base; 112 refers to sliding member; 1121 refers to first through hole; 1122 refers to second through hole; 113 refers to supporting stand; 114 refers to supporting member; 115 refers to triggering apparatus; 1151 refers to hand-shifting member; 1152 refers to clamping member; 1153 refers to elastic member; 120 refers to guide rail member; 130 refers to telescopic member; 140 refers to first battery; 141 refers to first electrical connection portion; 142 refers to first avoidance hole; 143 refers to second avoidance hole; 150 refers to circuit board; 151 refers to charging interface; 152 refers to power button; 1000 refers to electronic assembly; 200 refers to electronic device; and 210 refers to fourth electrical connection portion.

### DETAILED DESCRIPTION OF PREFERRED EMBODIMENTS

Embodiments of the present disclosure are described hereinafter in detail, and illustrations of the embodiments are shown in the accompanying drawings, where identical or similar reference numerals denote identical or similar elements or elements having the same or similar functions. The embodiments described hereinafter with reference to the accompanying drawings are exemplary, and are only intended to explain the present disclosure, but should not be understood as limiting the present disclosure.

In the description of the present disclosure, it should be understood that the orientation or position relationship indicated by the terms “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial”, “radial”, “circumferential”, and the like is based on the orientation or position relationship shown in the drawings, it is only for the convenience of description of the present disclosure and simplification of the description, and it is not to indicate or imply that the indicated device or element must have a specific orientation, and be constructed and operated in a specific orientation. Therefore, the terms should not be understood as limiting the present disclosure.

Moreover, the terms “first” and “second” are only used for descriptive purposes, but cannot be understood as indicating or implying relative importance, or implicitly indicating the number of indicated technical features. Therefore, the feature defined by “first” and “second” may explicitly or implicitly include one or more of the features. In the description of the present disclosure, the meaning of “multiple” refers to being two or more than two, unless otherwise specifically defined.

In the present disclosure, the terms “mounting”, “connected”, “connection”, “fixation”, and the like should be understood in broad sense unless otherwise specified and defined. For example, they may be fixed connection, removable connection or integrated connection; may be mechanical connection or electrical connection; and may be direct connection, or indirect connection through an intermediate medium, and connection inside two components, or interaction relation of two elements. The specific meanings of the above terms in the present disclosure may be understood in a specific case by those of ordinary skills in the art.

In the present disclosure, unless otherwise specified and limited, the first feature “on” or “under” the second feature may be direct contact between the first feature and the second feature, and may also be indirect contact between the first feature and the second feature through an intermediate medium. Furthermore, the first feature “on”, “above” and “over” the second feature refers to that the first feature is directly above and obliquely above the second feature, or only indicates that the first feature is higher than the second feature in a horizontal height. The first feature “under”, “below” and “underneath” the second feature may refer to that the first feature is directly below and obliquely below the second feature, or only indicates that the first feature is lower than the second feature in a horizontal height.

### First Embodiment

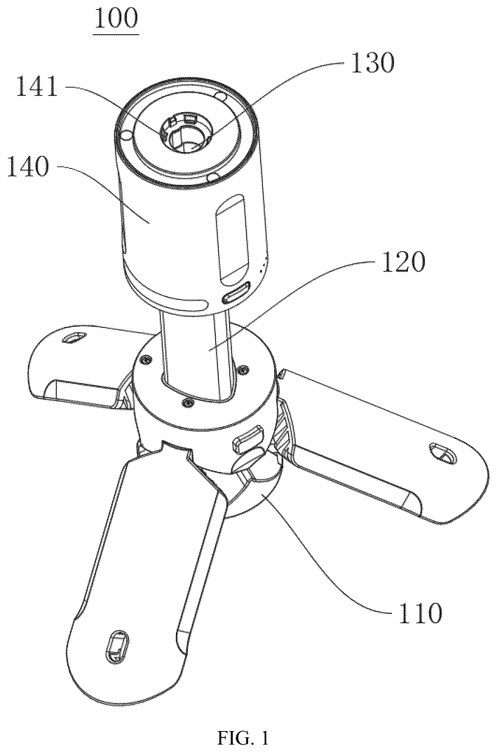

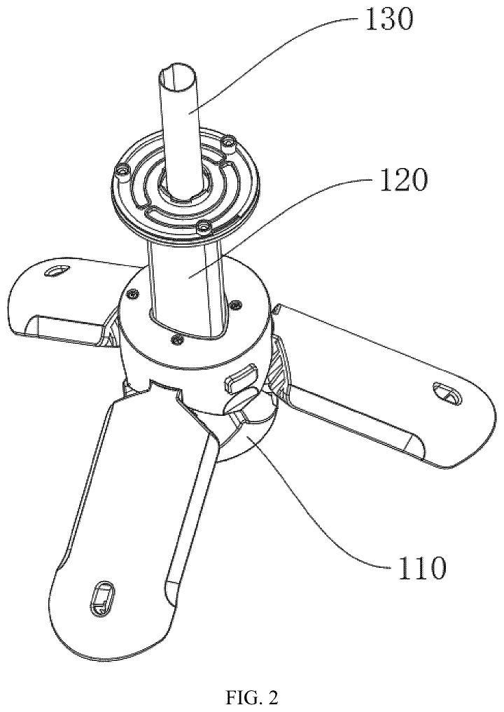

As shown in FIG. 1 and FIG. 2, this embodiment of the present disclosure provides an outdoor mobile power supply 100, which is mainly applied to an electronic assembly 1000. The outdoor mobile power supply 100 comprises a base assembly 110, a guide rail member 120, a telescopic member 130 and a first battery 140.

The guide rail member 120 is arranged on the base assembly 110, the telescopic member 130 is arranged on the base assembly 110, and a part of the telescopic member 130 is located in the guide rail member 120; and the first battery 140 is arranged on the guide rail member 120 and sleeved on the telescopic member 130, and one end of the first battery 140 far away from the guide rail member 120 is provided with a first electrical connection portion 141.

According to the outdoor mobile power supply 100 provided in this embodiment of the present disclosure, by arranging both the guide rail member 120 and the telescopic member 130 on the base assembly 110, and locating one part of the telescopic member 130 in the guide rail member 120, a function of stably mounting the guide rail member 120 and the telescopic member 130 is realized, and the telescopic member 130 can be extended or retracted relative to the guide rail member 120.

By arranging the first battery 140 on the guide rail member 120 and sleeving the first battery on the telescopic member 130, a function of stably mounting the first battery 140 is realized, and meanwhile, by arranging the first electrical connection portion 141 at one end of the first battery 140 far away from the guide rail member 120, when the outdoor mobile power supply 100 is used, a user can extend the telescopic member 130 and sleeve other batteries on the telescopic member 130 in series in sequence, so as to expand a capacity of the outdoor mobile power supply 100, and when the outdoor mobile power supply 100 is transported, the user can remove other batteries from the telescopic member 130 in sequence and retract the telescopic member 130, so as to reduce a weight of the outdoor mobile power supply 100, thus being convenient to use, carry and move. According to the outdoor mobile power supply 100 provided by the present disclosure, the user can flexibly assemble and disassemble the battery according to the needs of use and mobile transportation, thus effectively improving the convenience of use, carrying and moving.

In one embodiment of the present disclosure, optionally, the outdoor mobile power supply 100 further comprises at least one second battery, one second battery is sleeved on the telescopic member 130 and electrically connected with the first electrical connection portion 141, and the remaining second batteries are sleeved on the telescopic member 130 in an axial direction of the telescopic member 130 in sequence and electrically connected in sequence.

In this embodiment, by providing at least one second battery, sleeving one second battery on the telescopic member 130 and electrically connecting the second battery with the first electrical connection portion 141, and sleeving the remaining second batteries on the telescopic member 130 in the axial direction of the telescopic member 130 in sequence and electrically connecting the second batteries in sequence, when the outdoor mobile power supply 100 is used, the user can extend the telescopic member 130 and sleeve the second batteries on the telescopic member 130 in series in sequence, so as to expand a capacity of the outdoor mobile power supply 100, and when the outdoor mobile power supply 100 is transported, the user can remove the second batteries from the telescopic member 130 in sequence and retract the telescopic member 130, so as to reduce a weight of the outdoor mobile power supply 100, thus being convenient to use, carry and move. Furthermore, the user can flexibly assemble and disassemble the second battery according to the needs of use and mobile transportation, thus effectively improving the convenience of use, carrying and moving.

In the above embodiment of the present disclosure, optionally, the second battery is provided with a second electrical connection portion and a third electrical connection portion, the second electrical connection portion and the third electrical connection portion are respectively located at two ends of the second battery, a second electrical connection portion of one second battery is electrically connected with the first electrical connection portion 141, and a third electrical connection portion of one second battery is electrically connected with a second electrical connection portion of an adjacent second battery.

In this embodiment, by respectively arranging the second electrical connection portion and the third electrical connection portion at two ends of the second battery, electrically connecting the second electrical connection portion of one second battery with the first electrical connection portion 141, and electrically connecting the third electrical connection portion of the second battery with the second electrical connection portion of the adjacent second battery, the first battery 140 and the multiple second batteries are electrically connected in series in sequence, thus expanding the capacity of the outdoor mobile power supply 100.

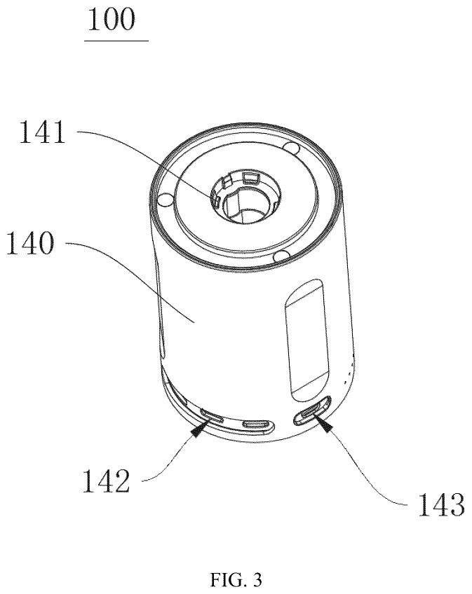

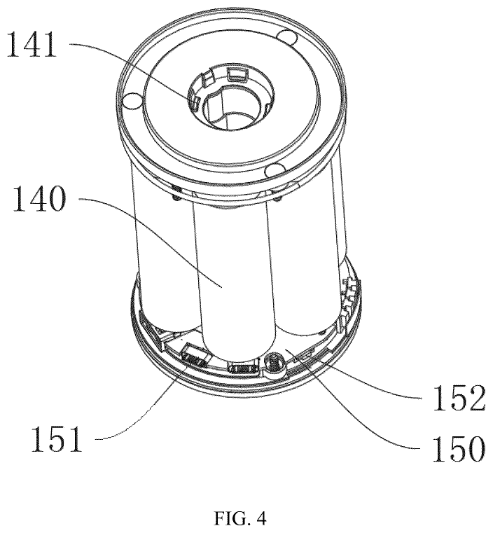

As shown in FIG. 3 and FIG. 4, in one embodiment of the present disclosure, optionally, the outdoor mobile power supply 100 further comprises a circuit board 150, and the circuit board 150 is arranged in a shell of the first battery 140 and electrically connected with the first battery 140. Therefore, by arranging the circuit board 150, a function of controlling charge and discharge of the first battery 140 is realized.

As shown in FIG. 3 and FIG. 4, in the above embodiment of the present disclosure, optionally, the circuit board 150 is provided with a charging interface 151, and the shell of the first battery 140 is provided with a first avoidance hole 142 matched with the charging interface 151. Therefore, the user can charge the outdoor mobile power supply 100 by using a data cable matched with the charging interface 151 or charge outdoor devices such as a mobile phone by using the outdoor mobile power supply 100.

As shown in FIG. 3 and FIG. 4, in the above embodiment of the present disclosure, optionally, the circuit board 150 is provided with a power button 152, and the shell of the first battery 140 is provided with a second avoidance hole 143 matched with the power button 152. Therefore, by pressing the power button 152, the user can turn on or off the outdoor mobile power supply 100.

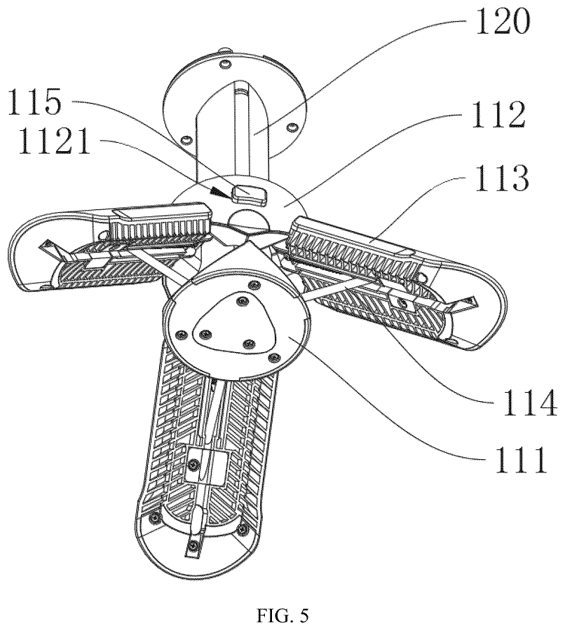

As shown in FIG. 5, in one embodiment of the present disclosure, optionally, the base assembly 110 comprises a base 111, a sliding member 112, a supporting stand 113 and a supporting member 114, the guide rail member 120 is arranged on the base 111, the sliding member 112 is slidably sleeved on the guide rail member 120, one end of the supporting stand 113 is hinged with the sliding member 112, and the supporting member 114 is hinged with the supporting stand 113 and the base 111 respectively.

In this embodiment, by arranging the guide rail member 120 on the base 111, a function of stably mounting the guide rail member 120 is realized. By slidably sleeving the sliding member 112 on the guide rail member 120, one end of the supporting stand 113 is hinged with the sliding member 112, and the supporting member 114 is hinged with the supporting stand 113 and the base 111 respectively.

Specifically, the sliding member 112 may freely slide on the guide rail member 120, and the sliding member 112 will not slide out of the guide rail member 120 due to a limitation by the base 111 while moving to a bottom to be in contact with the base 111. One end of the supporting stand 113 is hinged with the sliding member 112, so that the supporting stand 113 may rotate relative to the sliding member 112, and the supporting member 114 is hinged with the supporting stand 113 and the base 111 respectively, so that the supporting member 114 may rotate relative to the supporting stand 113 and the base 111.

When the sliding member 112 is forced and squeezed to move towards the base 111, a distance between the sliding member 112 and the base 111 is shortened, and a downward pressure of the sliding member 112 and an upward supporting force of the base 111 may produce an outward resultant force. At this time, the supporting stand 113 is opened outwardly under the resultant force, that is, the supporting stand 113 is in an opened state, so as to increase a radius of a ground supporting point, thus effectively improving standing stability of the outdoor mobile power supply 100, so that the outdoor mobile power supply 100 may also stand stably even in an inclined state.

Correspondingly, when the sliding member 112 is pulled upwardly, there may be an opposite acting force, and the supporting stand 113 may be closed inwardly under the acting force, so that the supporting stand 113 is opened and closed by moving the sliding member 112, and has a smaller volume in a closed state, thus being convenient to carry.

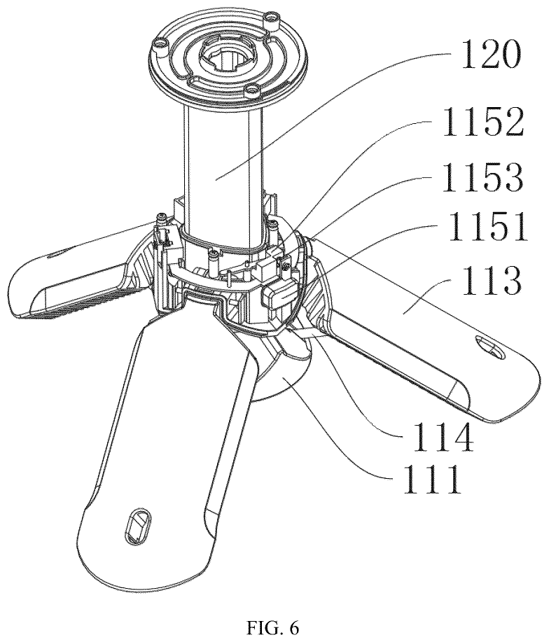

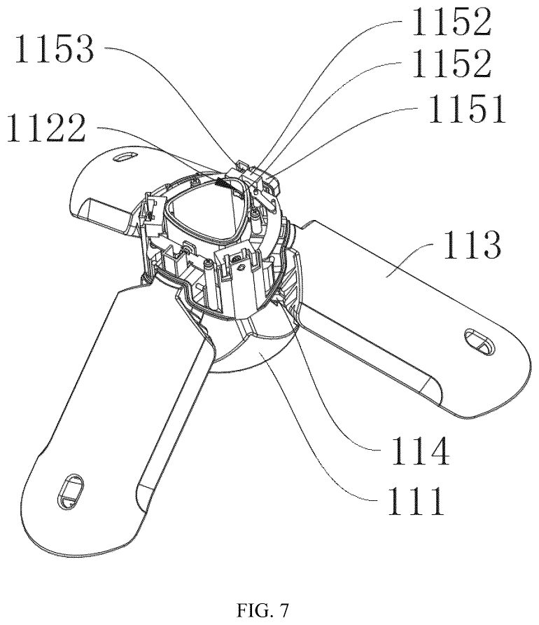

As shown in FIG. 6 and FIG. 7, in the above embodiment of the present disclosure, optionally, the base assembly 110 further comprises a triggering apparatus 115, the triggering apparatus 115 is arranged in the sliding member 112, the triggering apparatus 115 comprises a hand-shifting member 1151, a clamping member 1152 and an elastic member 1153, the sliding member 112 is provided with a first through hole 1121 and a second through hole 1122, the hand-shifting member 1151 movably penetrates through the first through hole 1121 and is connected with the clamping member 1152, one end of the clamping member 1152 movably penetrates through the second through hole 1122 and abuts against the guide rail member 120, and the elastic member 1153 abuts against one end of the clamping member 1152 far away from the second through hole 1122 and the sliding member 112 respectively.

In this embodiment, by making one end of the clamping member 1152 movably penetrate through the second through hole 1122 of the sliding member 112 and abut against the guide rail member 120, the elastic member 1153 abuts against one end of the clamping member 1152 far away from the second through hole 1122 and the sliding member 112 respectively, and the elastic member 1153 is in a compressed state, so that one end of the clamping member 1152 is automatically driven to penetrate through the second through hole 1122 by an elastic force of the elastic member 1153 to abut against the guide rail member 120, so as to make the sliding member 112 unable to slide relative to the guide rail member 120, thus stably keeping the supporting stand 113 in the opened or closed state.

By making the hand-shifting member 1151 movably penetrate through the first through hole 1121 of the sliding member 112 and connecting the hand-shifting member with the clamping member 1152, when the supporting stand 113 needs to be opened or closed, the user can shift the hand-shifting member 1151 to drive one end of the clamping member 1152 to retract into the second through hole 1122, so that the clamping member 1152 is separated from the guide rail member 120, so as to make that the sliding member 112 slide relative to the guide rail member 120, thus enabling the supporting stand 113 to be opened or closed.

In a process that the user shifts the hand-shifting member 1151 to drive one end of the clamping member 1152 to retract into the second through hole 1122 to separate the clamping member 1152 from the guide rail member 120, the elastic piece 1153 is further compressed and generates a reset elastic force, so that when the user releases the hand-shifting member 1151 after the supporting stand 113 is opened or closed, the clamping member 1152 is reset to abut against and press the guide rail member 120 again under the reset elastic force, and the hand-shifting member 1151 is driven to reset.

### Second Embodiment

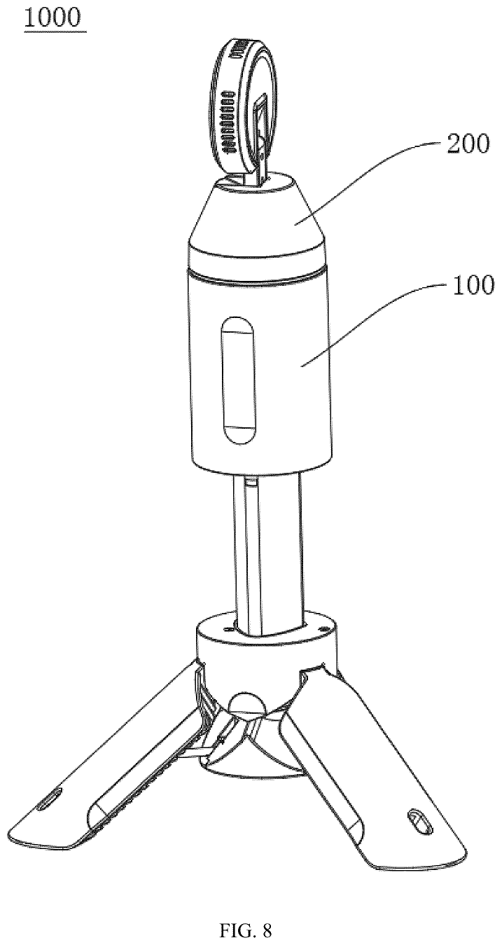

As shown in FIG. 8, Second Embodiment pf the present disclosure further provides an electronic assembly 1000, which comprises an electronic device 200 and the outdoor mobile power supply 100 in First Embodiment above.

Illustratively, the electronic device 200 may be a camping lamp, a wireless charging device, a mosquito killer, and the like.

The electronic assembly 1000 has the outdoor mobile power supply 100 in First Embodiment, so that the electronic assembly has all the beneficial effects of the outdoor mobile power supply 100 in First Embodiment, which will not be repeated herein.

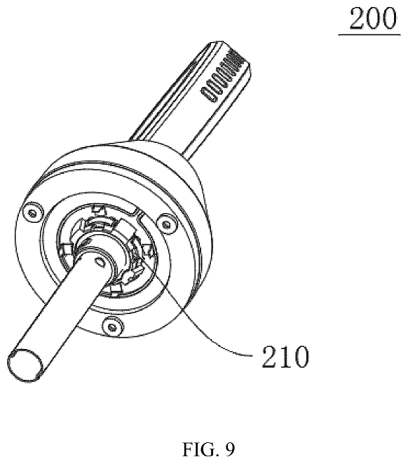

As shown in FIG. 9, in the above embodiment of the present disclosure, optionally, one end of the electronic device 200 is provided with a fourth electrical connection portion 210 electrically connected with the first electrical connection portion 141.

In this embodiment, by arranging the fourth electrical connection portion 210 electrically connected with the first electrical connection portion 141 at one end of the electronic device 200, the electronic device 200 is electrically connected with the outdoor mobile power supply 100, so as to realize a function of supplying power for the electronic device 200.

To sum up, the present disclosure provides the outdoor mobile power supply, and the outdoor mobile power supply comprises the base assembly, the guide rail member, the telescopic member and the first battery. By arranging both the guide rail member and the telescopic member on the base assembly, and locating one part of the telescopic member in the guide rail member, a function of stably mounting the guide rail member and the telescopic member is realized, and the telescopic member can be extended or retracted relative to the guide rail member. By arranging the first battery on the guide rail member and sleeving the first battery on the telescopic member, a function of stably mounting the first battery is realized, and meanwhile, by arranging the first electrical connection portion at one end of the first battery far away from the guide rail member, when the outdoor mobile power supply is used, a user can extend the telescopic member and sleeve other batteries on the telescopic member in series in sequence, so as to expand a capacity of the outdoor mobile power supply, and when the outdoor mobile power supply is transported, the user can remove other batteries from the telescopic member in sequence and retract the telescopic member, so as to reduce a weight of the outdoor mobile power supply, thus being convenient to use, carry and move. According to the outdoor mobile power supply provided by the disclosure, a user can flexibly assemble and disassemble the battery according to the needs of use and mobile transportation, thus effectively improving the convenience of use, carrying and moving.

In the descriptions of the specification, the descriptions with reference to the terms “one embodiment”, “some embodiments”, “example”, “specific example” or “some examples”, and the like refer to that specific features, structures, materials or characteristics described with reference to the embodiments or examples are included in at least one embodiment or example of the present disclosure. In the specification, the schematic representation of the above terms does not necessarily refer to the same embodiment or example. Moreover, the specific features, structures, materials or characteristics described may be combined in any one or more embodiments or examples in a suitable manner. In addition, in the case of having no mutual contradiction, those skilled in the art may join and combine different embodiments or examples described in the specification and the characteristics of the different embodiments or examples.

Although the embodiments of the present disclosure have been shown and described above, it may be understood that the above embodiments are exemplary and cannot be understood as limiting the present disclosure, and those of ordinary skills in the art may make changes, modifications, substitutions and variations to the above embodiments within the scope of the present disclosure.

### INDUSTRIAL APPLICABILITY

The present disclosure provides the outdoor mobile power supply and the electronic assembly. The outdoor mobile power supply comprises the base assembly, the guide rail member, the telescopic member and the first battery. By arranging both the guide rail member and the telescopic member on the base assembly, and locating one part of the telescopic member in the guide rail member, a function of stably mounting the guide rail member and the telescopic member is realized, and the telescopic member can be extended or retracted relative to the guide rail member. By arranging the first battery on the guide rail member and sleeving the first battery on the telescopic member, a function of stably mounting the first battery is realized, and meanwhile, by arranging the first electrical connection portion at one end of the first battery far away from the guide rail member, when the outdoor mobile power supply is used, a user can extend the telescopic member and sleeve other batteries on the telescopic member in series in sequence, so as to expand a capacity of the outdoor mobile power supply, and when the outdoor mobile power supply is transported, the user can remove other batteries from the telescopic member in sequence and retract the telescopic member, so as to reduce a weight of the outdoor mobile power supply, thus being convenient to use, carry and move. According to the outdoor mobile power supply provided by the disclosure, a user can flexibly assemble and disassemble the battery according to the needs of use and mobile transportation, thus effectively improving the convenience of use, carrying and moving.

Furthermore, it can be understood that the outdoor mobile power supply and the electronic assembly provided by the present disclosure are reproducible and can be used in various industrial applications. For example, the outdoor mobile power supply and the electronic assembly provided by the present disclosure may be used in the field of power supply in outdoor environment.

We claim:

1. An outdoor mobile power supply, comprising:
a base assembly;
a guide rail member, wherein the guide rail member is arranged on the base assembly;
a telescopic member, wherein the telescopic member is arranged on the base assembly, and a part of the telescopic member is located in the guide rail member; and
a first battery, wherein the first battery is arranged on the guide rail member and sleeved on the telescopic member, and one end of the first battery far away from the guide rail member is provided with a first electrical connection portion.

2. The outdoor mobile power supply according to claim 1, wherein the outdoor mobile power supply further comprises at least one second battery, one second battery is sleeved on the telescopic member and electrically connected with the first electrical connection portion, and the remaining second batteries are sleeved on the telescopic member in an axial direction of the telescopic member in sequence and electrically connected in sequence.

3. The outdoor mobile power supply according to claim 2, wherein the second battery is provided with a second electrical connection portion and a third electrical connection portion, the second electrical connection portion and the third electrical connection portion are respectively located at two ends of the second battery, a second electrical connection portion of one second battery is electrically connected with the first electrical connection portion, and a third electrical connection portion of one second battery is electrically connected with a second electrical connection portion of an adjacent second battery.

4. The outdoor mobile power supply according to claim 1, wherein the outdoor mobile power supply further comprises a circuit board, and the circuit board is arranged in a shell of the first battery and electrically connected with the first battery.

5. The outdoor mobile power supply according to claim 4, wherein the circuit board is provided with a charging interface, and the shell of the first battery is provided with a first avoidance hole matched with the charging interface.

6. The outdoor mobile power supply according to claim 4, wherein the circuit board is provided with a power button, and the shell of the first battery is provided with a second avoidance hole matched with the power button.

7. The outdoor mobile power supply according to claim 1, wherein the base assembly comprises a base, a sliding member, a supporting stand and a supporting member, the guide rail member is arranged on the base, the sliding member is slidably sleeved on the guide rail member, one end of the supporting stand is hinged with the sliding member, and the supporting member is hinged with the supporting stand and the base respectively.

8. The outdoor mobile power supply according to claim 7, wherein the base assembly further comprises a triggering apparatus, the triggering apparatus is arranged in the sliding member, the triggering apparatus comprises a hand-shifting member, a clamping member and an elastic member, the sliding member is provided with a first through hole and a second through hole, the hand-shifting member movably penetrates through the first through hole and is connected with the clamping member, one end of the clamping member movably penetrates through the second through hole and abuts against the guide rail member, and the elastic member abuts against one end of the clamping member far away from the second through hole and the sliding member respectively.

9. An electronic assembly, comprising an electronic device and the outdoor mobile power supply according to claim 1.

10. The electronic assembly according to claim 9, wherein one end of the electronic device is provided with a fourth electrical connection portion electrically connected with the first electrical connection portion.
